(19) United States
(12) Patent Application Publication
(10) Pub. No.: US 2014/0025687 A1
(43) Pub. Date: Jan. 23, 2014

(54) Analyzing a report

(71) Applicant: Koninklijke Philips N.V, Eindhoven (NL)

(72) Inventors: Zarko Aleksovski, Eindhoven (NL); Roland Johannes Opfer, Hamburg (DE); Merlijn Sevenster, Chicago, IL (US); Arvid Randal Nicolaas, Tilburg (NL)

(73) Assignee: Koninklijke Philips N.V, Eindhoven (NL)

(21) Appl. No.: 13/944,070

(22) Filed: Jul. 17, 2013

Related U.S. Application Data
(60) Provisional application No. 61/672,330, filed on Jul. 17, 2012.

(30) Foreign Application Priority Data
Jul. 17, 2012 (EP) 12176648.9

(51) Int. Cl. G06F 17/30

(52) U.S. Cl. CPC G06F 17/30011
USPC 707/748

(57) ABSTRACT

A report analyzing system (1) is described. A text processing unit (2) analyzes a text portion (13, 23, 45) of a report. The text portion is in a natural language. The processing unit identifies a concept (41, 42, 43, 44) in the text portion, to obtain a set of identified concepts. A concept ranking unit (3) ranks the concepts (41, 42, 43, 44) of the set of identified concepts based on a ranking criterion, to obtain a ranking. A concept selector (4) selects at least one concept of the set of identified concepts based on the ranking, to obtain at least one selected concept. An associating unit (5) associates a visual representation (31, 32, 33, 34) with the report based on the at least one selected concept. The selected concept may belong to an ontology, e.g. a medical ontology.

### FIELD OF THE INVENTION

The invention relates to a system and method for analyzing a report, in particular a medical report of a patient

### BACKGROUND OF THE INVENTION

Healthcare environments, such as hospitals or clinics, are increasingly becoming paperless nowadays. As a result, information about patients and their medical encounters that were formerly stored and distributed in paper format are now and stored in a digital format in hospital information systems such as electronic medical records (EMRs) or in other more specialized information systems such as an oncology information system.

Besides having data in electronic form, EMRs offer a wide variety of ways to support the clinical workflow, for example the ability to search for information throughout the patient's medical history, structuring information in a patient's file, as well as selecting most important pieces of information to ensure that treating physicians will take all important information into account when making their decisions on how to proceed with treating a patient.

Nevertheless, physicians usually have to review many text records of patients to obtain an understanding of a current patient case. In this reviewing process they might be searching for specific medical information. It might be difficult for them to determine which particular text document contains the specific information required. Therefore, although time consuming and tedious, cross reading of various text documents might be inevitable in order to find the specific information physicians are looking for. Thus, there is a need for quickly obtaining an accurate and reliable overview of a patient's medical situation and/or quickly finding specific medical information in the patient's medical record.

US 2011/0161854 A1 discloses systems and methods for visual presentation of clinical evidence to a user in association with a patient's anatomy. In certain embodiments of the invention according to this reference, a patient information interface system to present an aggregated, graphical view of patient anatomy and history includes a data store to include images and patient history information and a processor to implement a user interface to accept user input. The graphical view includes one or more indicators located at an anatomical location of the patient anatomy within the view, such indicators representing clinical events.

### SUMMARY OF THE INVENTION

It would be advantageous to have an improved system for analyzing a report. To better address this concern, a first aspect of the invention provides a system comprising

a text processing unit for analyzing a text portion of the report to identify a concept in the text portion, to obtain a set of identified concepts;

a concept ranking unit for ranking the concepts of the set of identified concepts based on a ranking criterion, to obtain a ranking;

a concept selector for selecting at least one concept of the set of identified concepts based on the ranking, to obtain at least one selected concept; and

an associating unit for associating a visual representation with the report based on said at least one selected concept.

The system can provide an automatically generated visual summary of text reports, e.g. medical text reports in a specific clinical context. Depending on the visual summary that comprises visual representations associated with the text report based on the selected concepts, the physician can then decide to have a closer look at the report or to discard it. This is a much quicker and more convenient way than opening a text report and reading through it.

In order to create the visual summary, relevant concepts that may be present in a natural language in the patient's medical report are identified by means of text processing. Thus, a set of identified concepts is obtained. “Concepts” according to the invention should be understood to correspond to generally used medical terms and definitions, for example, terms and definitions according to a medical ontology such as the Systematized Nomenclature of Medicine Clinical Terms (SNOMED CT).

The concept ranking unit provides a ranking of the identified concepts in this set based on a ranking criterion. Examples of a ranking criterion are importance of the identified concepts with respect to the patient's treatment, and/or importance of the identified concepts with respect to that particular report.

Subsequently, the concept selector selects at least one identified concept of the abovementioned set based on the ranking, to obtain at least one selected concept. For example, the most important and/or most representative concepts from the report can thus be selected. Examples of such concepts are those that only occur rarely or even once in a specific text report, but for which it is very important that a physician will not overlook them.

Next, the associating unit associates to the report a visual representation based on the at least one selected concept. The visual representation, which for example can comprise a pictogram, an icon, an image, a catchword and/or a text character, can then be displayed in order to provide a visual summary of the text report. Thus, a quick overview of the relevant information comprised by the text report can be provided enabling the physician to quickly decide whether he wants to read this text report in more detail or to discard it.

The system may further comprise a display unit for displaying a visual summary of the report, wherein the visual summary comprises at least one visual representation of the report based on at least one selected concept. Such a visual summary allows a user, e.g. a physician, to quickly assess the most relevant content of the report without having to read through it. As a result, the user can quickly decide how to deal with the report, i.e. consider it or discard it. The display unit can for example be a computer screen and/or a screen of a tablet computer. The display unit may be arranged for facilitating user interaction with the displayed visual summary and/or the at least one visual representation.

The display unit may be arranged to display visual summaries of a set of reports within a record. In this way it may be possible for the physician to quickly get an overview of which reports in a record, which for example represents a patient, are relevant for taking a decision with respect to the medical condition of the patient.

The display unit may be arranged to display visual summaries of a set of records. This allows the physician to choose a particular record out of the set of records based on the visual summaries of the records. If the set of records represents a set of patients, it may thus be possible to select a patient from the set of patients.

The system may further comprise a time line generator for associating a position on a time line with a visual summary of the report. Such a representation of a visual summary of a report allows the physician to quickly get an overview of the medical condition of a patient over time. It will be clear to the skilled person that also a plurality of visual summaries of a plurality of corresponding reports may be represented on the time line. The visual summary can be arranged such that it provides access to the full natural language text of the report. This can for example be achieved by clicking the visual representation with a pointing device such as a computer mouse in the case of a conventional display unit or with a finger in the case of a touch screen.

The system may further comprise a combiner for generating a combined visual representation based on at least two selected concepts and a relationship between said at least two concepts. In this way it would be possible to generate a combined visual representation based on a first visual representation for a first selected concept and a second visual representation for a second selected concept. As an example a combined visual representation could be generated using a representation for breasts and a representation for a tumor to indicate the location of the tumor in for example a left breast of a patient.

The concept ranking unit may be arranged for ranking a concept of the set of identified concepts based on a clinical context of the report. If a patient is treated for example for breast cancer, it may be appropriate to indicate for example medications for treating breast cancer as important concepts in the report. Such concepts may be ranked higher than concepts identified in the report that are not or not directly related to treating breast cancer. Ranking of identified concepts based on the context of the report may thus be used to rank identified concepts within one report based on how important these concepts are with respect to a specific medical condition of the patient. Such a first type of ranking may be implemented by assigning primary relevance values to the identified concepts within the report according to a second mapping based on the context of the report.

The concept ranking unit may be arranged for ranking a concept of the set of identified concepts of the report based on identified concepts in other reports within a record. This allows ranking of the identified concepts based on how representative they are for the particular report in which they have been identified. A first concept that for example is identified in all text reports within a record may be less representative for these text reports than a second concept that is identified in for example only one text report within the record.

The concept ranking unit may be arranged for ranking a first identified concept higher than a second identified concept if the first identified concept is less frequently identified in the reports within the record than the second identified concept. For example, if a patient is treated for lung cancer and most of the reports mention lung cancer then this concept should not be visually represented in the visual summaries of the reports within the record. Instead, in the visual summaries of these reports concepts should be visually represented that are special for the corresponding report. Such a second type of ranking may be achieved by assigning a secondary relevance value to the second identified concept such that it is ranked higher than the first identified concept. It may be appropriate that a visual representation for the higher ranked concept appears in the visual summary of the particular report in which it has been identified.

It will be clear to the skilled person that instead of using frequency of occurrence of a concept in the reports within a record as mentioned above also a general importance measure such as Term Frequency-Inverse Document Frequency (TFIDF) can be used for ranking concepts identified in the reports within a record to determine how representative they are for the particular report in which they have been identified.

It will also be clear to the skilled person that the first and second types of ranking as described above can be combined. It may for example be possible to first rank identified concepts based on the context of the report and subsequently rank them on how representative they are for the particular report in which they have been identified.

The text processing unit may be arranged for associating a word in the text portion with a concept belonging to an ontology. Using an ontology a word in a natural language text can be associated with a concept belonging to an ontology based on a relationship between concepts and a meaning of the concepts. The ontology used may for example be a medical ontology such as SNOMED CT.

The associating unit may be arranged for using a mapping that maps visual representations with concepts. The visual representations may be predetermined and stored in a storage system of the report analyzing system. The mapping may establish a relationship between visual representations and concepts. The mapping may be implemented for example as a look-up table. Based on the mapping the associating unit may associate visual representations with concepts in a text report. The concepts may for example be selected concepts that belong to an ontology, e.g. a medical ontology. As an example, the mapping may enable the associating unit to associate a first concept “mastectomy” with a schematic drawing of a breast with a scalpel and a second concept “adjuvant chemo therapy” with a picture of an infusion bag. The collection of these two visual representations may then be used to provide the visual summary of the text report.

The associating unit may be arranged for associating the visual representation with the report in the case of a selected concept that is related to a concept according to an ontology. In this way it may not be necessary to associate a different visual representation with a first and a second selected concept if these concepts are related. This relationship may for example be based on an ontology, e.g. a medical ontology. This allows generalization with respect to associating visual representations with concepts.

In another aspect, the invention provides a workstation comprising the report analyzing system set forth.

In another aspect, the invention provides a method of analyzing a report. The method comprises the steps of

analyzing a text portion of a report to identify a concept of an ontology in the text portion, to obtain a set of identified concepts;

ranking the concepts of the set of identified concepts based on a ranking criterion, to obtain a ranking;

selecting at least one concept of the set of identified concepts based on the ranking, to obtain at least one selected concept; and

associating a visual representation with the report based on said at least one selected concept.

In another aspect, the invention provides a computer program product comprising instructions for causing a processor system to perform the method and/or to implement the system set forth.

It will be appreciated by those skilled in the art that two or more of the above-mentioned embodiments, implementations, and/or aspects of the invention may be combined in any way deemed useful.

Modifications and variations of the report analyzing system, the workstation, the report analyzing method and/or the computer program product, which correspond to the described modifications and variations of the system, can be carried out by a person skilled in the art on the basis of the present description.

### BRIEF DESCRIPTION OF THE DRAWINGS

These and other aspects of the invention are apparent from and will be elucidated with reference to the embodiments described hereinafter. In the drawings.

FIG. 1 is a block diagram of a system for analyzing a report.

FIG. 2 is an example of a visual summary comprising visual representations, e.g. pictograms and/or images, wherein each visual representation corresponds to one of the breast cancer concepts found in a report.

FIG. 3 is an example of reports being shown as icons on a time line, wherein for example by hovering over an icon a pop-up may appear showing a visual summary of the report. By clicking the icon a complete text of the report may be shown.

FIG. 4 is a flow chart of a method for analyzing a report.

### DETAILED DESCRIPTION OF EMBODIMENTS

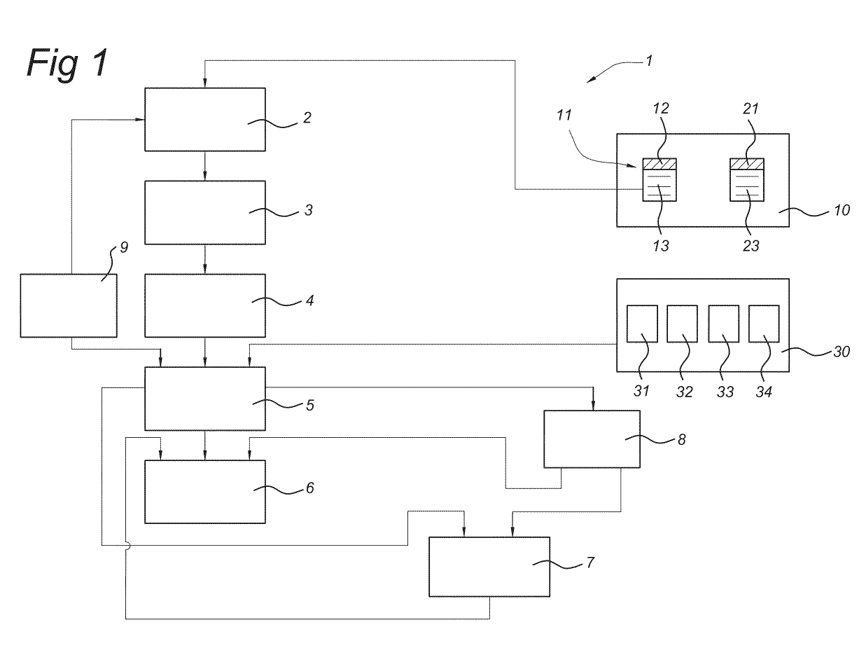

FIG. 1 illustrates a report analyzing system 1. This system 1 may be implemented on a distributed computer system, for example. Analyzing features may be implemented on a server system, whereas display features may be formed by a client device with a monitor that a user can see. Other arrangements, including a standalone workstation, may also be used to implement the features described herein. Alternatively, the system and/or method described herein may be implemented using dedicated electronic circuitry. Although the system 1 is described herein as comprising a number of units, it will be understood by the skilled person that the same functionality may be divided among a plurality of functional units in a different manner.

The system 1 may have access to a storage system that is capable of storing a collection of reports 10 and/or a collection of visual representations 30. This storage system may comprise a database system and/or a file system. For example, the storage system is part of a healthcare information system. The storage system may be part of the report analyzing system 1. Alternatively, the report analyzing system 1 may be connected to the storage system, for example via a network connection. The reports stored in the storage system and/or handled by the present report analyzing system may comprise two kinds of data, namely structured data fields 12 and/or a portion containing free text 13. Such free text 13, which may be in a natural language, could comprise the body of a medical report. In addition, a report may contain other kinds of data, such as image data or other kinds of measurement data. Any number of reports may be present in the collection of reports 10. For the purpose of explanation, only two reports 11 and 21 and only four visual representations 31-34 have been drawn here. It should be noted that a report may comprise any single one or any combination of structured data, free text, image data and other measurement data.

FIG. 1 shows that the report analyzing system 1 may comprise a text processing unit 2 for analyzing a text portion of a first report 11 in a collection of reports 10. For example, this first report is selected randomly or semi-randomly from the collection of reports. The collection of reports may consist of reports that are present in a particular record, such as a patient record, in the database. In such a case, all the reports may relate to the same patient. Alternatively, the collection of reports comprises reports form a plurality of records, such as different patient records, so that the collection of reports relates to a plurality of patients. The first report 11 may comprise text 13 in a natural language. Although the first report 11 may also comprise structured data 12, this is optional. By means of some text processing concepts, e.g. medical concepts, may automatically be identified in the text 13. The obtained set of identified concepts may belong to a given ontology 9, e.g. a medical ontology such as SNOMED CT.

The system 1 may comprise a concept ranking unit 3 that may be arranged for ranking the concepts of the set of identified concepts based on a ranking criterion to obtain a ranking. Examples of a ranking criterion are importance of the identified concepts with respect to the context of the record, e.g. determined by a particular treatment, and/or importance of the identified concepts with respect to that particular report, i.e. how representative are the identified concepts for that report.

To provide the abovementioned ranking, the concept ranking unit 3 may be arranged to first assign to each concept of the set of identified concepts a primary relevance value according to a second mapping based on a context of the report. The context may be a medical context, such as breast cancer or lung cancer. The skilled person knows how to determine such a mapping for concepts in a given context. The concept ranking unit 3 may also be arranged to subsequently assign a secondary relevance value to each concept of the set of identified concepts based on identified concepts in other reports in a record. Assigning the secondary relevance value may be done using standard information retrieval notions such as TFIDF, which may be used to measure how much the concept is representative for a particular report. This measure finds which concepts are “special” for this report, e.g. the concepts rarely occur in other reports. Depending on the application the primary and secondary relevance values may be combined in different ways to determine the ranking of a set of concepts identified in a text report.

The system 1 may comprise a concept selector 4 for selecting at least one concept of the set of identified concepts based on the abovementioned ranking, to obtain at least one selected concept. Thus, for example the most important and/or most representative concepts for a report may be selected. As mentioned above such concepts are for example concepts that only occur rarely or once in a specific text report but are very important not to be overlooked by a physician. For example, medications A and B are found in a report, but A can be found in many reports of the patient's record, e.g. aspirin may be prescribed to a patient more than ten times throughout the course of his or her medical history, while B can be found only in this particular report. Thus, advantage should be given to showing B for this particular report for obvious reasons that A can be shown for the other reports as well and if B is not shown then potentially important information may be missed.

The system 1 may comprise an associating unit 5 for associating a visual representation with the report based on the at least one selected concept. The visual representations, which can comprise pictograms, icons, images, schematic drawings and/or text characters, may be stored in the storage system that may be part of the report analyzing system 1. The visual representation for each selected concept may be determined offline. As described above the associating unit 5 may be arranged for using a mapping that maps visual representations with concepts. The mapping may establish a relationship between visual representations and concepts. The mapping may be implemented for example as a look-up table. Based on the mapping the associating unit 5 may associate visual representations 31-34 with concepts in a text portion 13 of a report 11. The concepts may for example be selected concepts that belong to an ontology 9, e.g. a medical ontology.

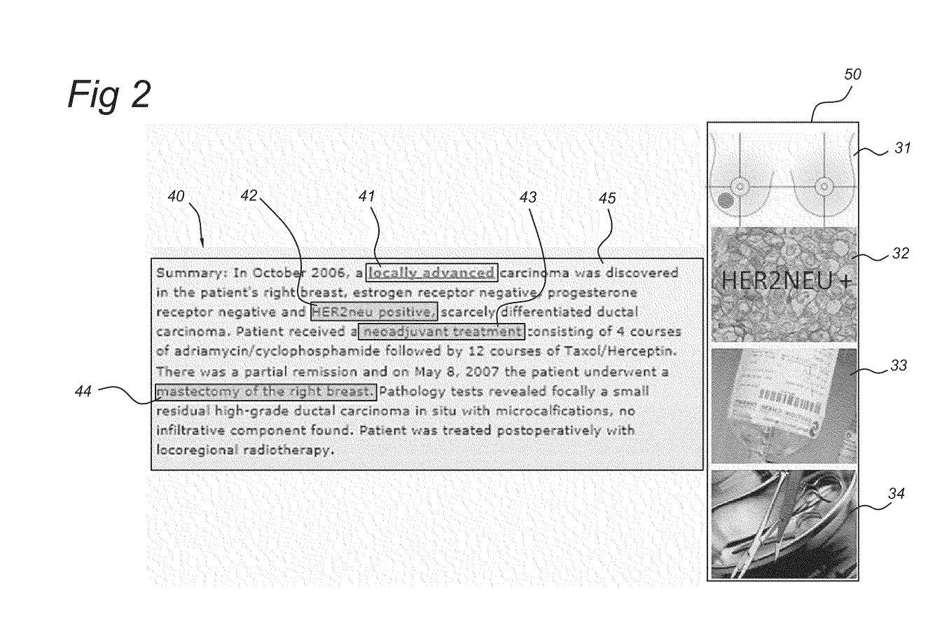

As an example, the mapping may enable the associating unit to associate a first concept “mastectomy” with a schematic drawing of a breast with a scalpel and a second concept “adjuvant chemo therapy” with a picture of an infusion bag. The collection of visual representations obtained may then be used to provide the visual summary of the text report 11. FIG. 2 shows an example of how this could look like.

In the text portion 45 of an exemplary report 40 shown in FIG. 2, four breast cancer concepts 41-44 have been identified and highlighted, namely the concepts “locally advanced”, “HER2neu positive”, “neoadjuvant treatment” and “mastectomy of the right breast”.

On the right hand side, an exemplary representation of a visual summary 50 for the report 40 is shown. Each of the visual representations 31-34 of the collection of visual representations 30 corresponds to one of the selected concepts 41-44.

FIG. 1 further shows that the system 1 may comprise a display unit 6 for displaying the visual summary of the text report. This display unit 6 can for example be a computer screen and/or a screen of a tablet computer. The display unit 6 may be arranged for facilitating user interaction with the displayed visual summary. It may also be possible to create a view for a physician and a different view which is comprehensible for a patient.

The display unit 6 may also be arranged to display visual summaries of a set of reports within a record, wherein each visual summary comprises the visual representation of the at least one selected concept of the corresponding report. In this way it may be possible for the physician to quickly get an overview of which reports in a patient's record are relevant for taking a decision with respect to the medical condition of the patient.

The display unit 6 may also be arranged to display visual summaries of a set of records. This allows the physician to choose a particular record out of the set of records based on the visual summaries of the records. If the set of records represents a set of patients, it may thus be possible for a physician to quickly identify which patient out of the set of patients deals with a certain disease, for example breast cancer. He can then easily select the record of this patient to obtain further information. After having chosen a particular record, the physician can get information about the content of the reports in the record through the visual summaries of these reports as described above.

The system 1 may comprise a time line generator 7 for associating a position on a time line with a visual summary of the report, wherein the visual summary comprises the visual representation of at least one selected concept.

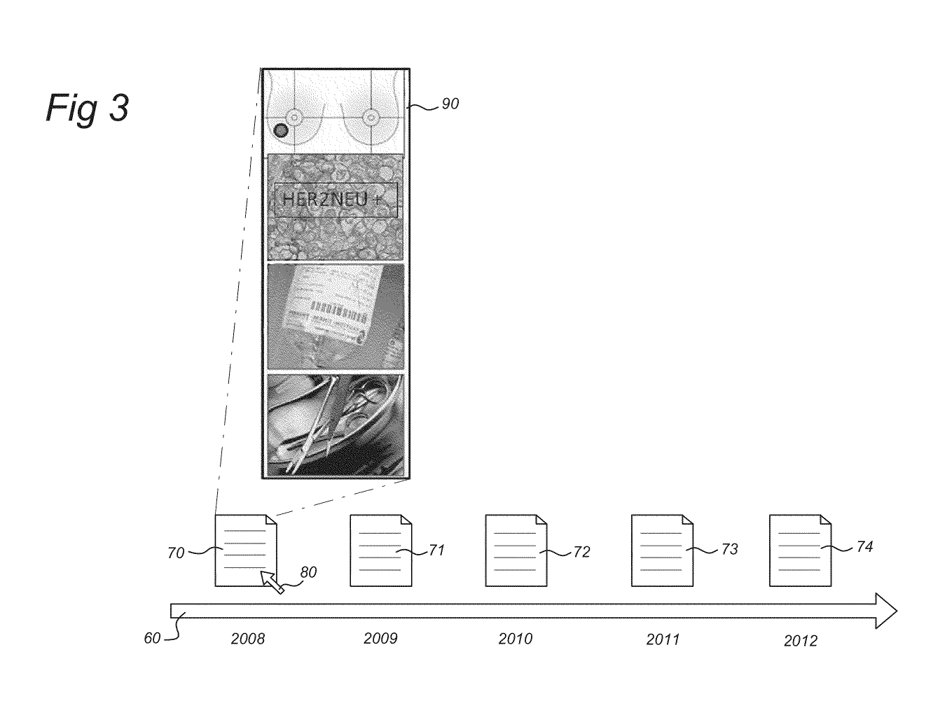

A timeline 60 visualizes a plurality of reports of the collection of reports 10 belonging to a patient in a rectangular schema according to a time associated therewith. Reports are usually represented via small icons 70-74 on the timeline 60. If the user for example hovers over an icon with a pointing device 80, a small pop-up window 90 could be opened showing the visual summary of the report. This is illustrated in FIG. 3. The visual summary might be arranged such that it provides access to the full natural language text of the report. This can for example be achieved by clicking on the icon with the pointing device 80, e.g. a computer mouse in the case of a conventional display unit 6 or with a finger in the case of a touch screen.

In the example shown in FIG. 3, a physician might open the report of which the visual summary is shown if he or she is looking for some detailed information about for example the chemo therapy the patient received in the past. However, if the physician was looking for some information related to a broken leg, he or she would discard this report immediately based on its visual summary and hover over the icon of the next text report to get a quick glance at its visual summary. In this way there may be no need to open and cross read a report which is completely irrelevant for a particular search. In addition, the physician can quickly get an overview of the medical condition of a patient over time.

The system 1 may comprise a combiner 8 for generating a combined visual representation based on at least two selected concepts and a relationship between said at least two concepts. In this way it would be possible to generate a combined visual representation based on a first visual representation for a first selected concept and a second visual representation for a second selected concept. As an example a combined visual representation could be generated using a representation for breasts and a representation for a tumor to indicate the location of the tumor in for example a left breast of a patient.

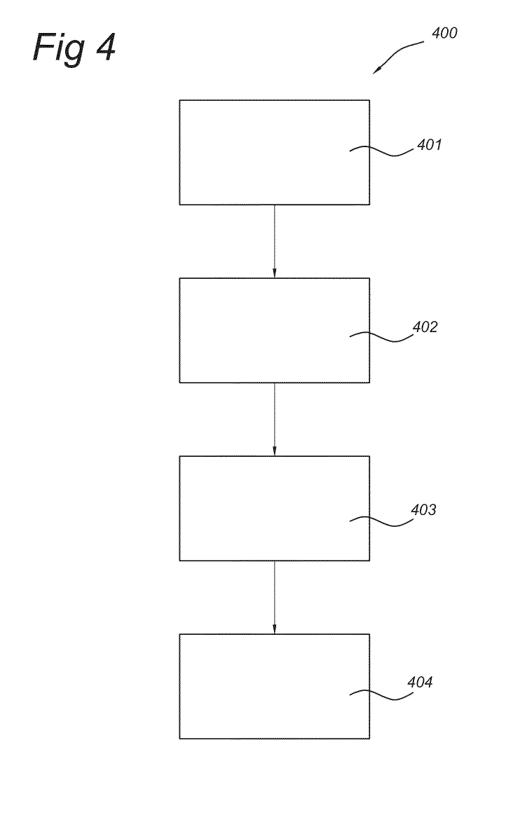

FIG. 4 illustrates a report analyzing method 400. In step 401 of the method, a text portion of the report, which may be in a natural language, is analyzed by means of text processing in order to identify a set of concepts in the report. In this way, a set of identified concepts is obtained.

In step 402 of the method, the concepts of the set of identified concepts obtained in step 401 are ranked based on a ranking criterion. In this way, a ranking of the concepts of the set of identified concepts is obtained.

In step 403 of the method, based on the ranking at least one concept of the set of identified concepts is selected. In this way, at least one selected concept is obtained.

In step 404 of the method, a visual representation is associated with the at least one selected concept.

It will be understood by the skilled person that the method 400 may be extended and/or modified based on the functionality described herein in respect of the report analyzing system 1. Moreover, the method 400 and the system 1 may be implemented by means of a computer program product.

The techniques described herein may be applicable across and beyond all the clinical information systems areas. Any medical system that allows some form of interaction with the whole or part of a patient record may provide additional benefit by implementing the techniques disclosed herein. Moreover, non-medical information systems may also benefit from these techniques.

It will be appreciated that the invention also applies to computer programs, particularly computer programs on or in a carrier, adapted to put the invention into practice. The program may be in the form of a source code, an object code, a code intermediate source and an object code such as in a partially compiled form, or in any other form suitable for use in a computer implementation of the method according to the invention.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, by means of a suitably programmed computer, or a combination thereof In the device claim enumerating several means, several of these means may be embodied by one and the same item of hardware. The mere fact that certain measures are recited in mutually different dependent claims does not indicate that a combination of these measures cannot be used to advantage.

1. A system (1) for analyzing a report, comprising
a text processing unit (2) for analyzing a text portion (13, 23, 45) of the report (11, 21, 40) to identify a concept in the text portion, to obtain a set of identified concepts;
a concept ranking unit (3) for ranking the concepts (41, 42, 43, 44) of the set of identified concepts based on a ranking criterion, to obtain a ranking;
a concept selector (4) for selecting at least one concept of the set of identified concepts based on the ranking, to obtain at least one selected concept; and
an associating unit (5) for associating a visual representation (31, 32, 33, 34) with the report based on said at least one selected concept.

2. The system (1) according to claim 1, wherein the system further comprises a display unit (6) for displaying a visual summary of the report, wherein the visual summary comprises at least one visual representation of the report based on at least one selected concept.

3. The system (1) according to claim 2, wherein the display unit (6) is arranged to display visual summaries of a set of reports within a record.

4. The system (1) according to claim 2, wherein the display unit (6) is arranged to display visual summaries of a set of records.

5. The system (1) according to claim 2, wherein the system further comprises a time line generator (7) for associating a position on a time line (60) with a visual summary of the report.

6. The system (1) according to claim 2, wherein the system further comprises a combiner (8) for generating a combined visual representation based on at least two selected concepts and a relationship between said at least two concepts.

7. The system (1) according to claim 1, wherein the concept ranking unit (3) is arranged for ranking a concept of the set of identified concepts in the report based on a context of the report.

8. The system (1) according to claim 1, wherein the concept ranking unit (3) is arranged for ranking a concept of the set of identified concepts of the report based on identified concepts in other reports within a record.

9. The system (1) according to claim 8, wherein the concept ranking unit (3) is arranged for ranking a first identified concept higher than a second identified concept if the first identified concept is less frequently identified in the reports within the record than the second identified concept.

10. The system (1) according to claim 1, wherein the text processing unit (2) is arranged for associating a word in the text portion with a concept belonging to an ontology.

11. The system (1) according to claim 1, wherein the associating unit (5) is arranged for using a mapping that maps visual representations with concepts.

12. The system (1) according to claim 1, wherein the associating unit (5) is arranged for associating the visual representation with the report in the case of a selected concept that is related to a concept according to an ontology.

13. A workstation comprising the system according to claim 1.

14. A method (400) for analyzing a report, comprising
analyzing a text portion of a report to identify a concept of an ontology in the text portion, to obtain a set of identified concepts;
ranking the concepts of the set of identified concepts based on a ranking criterion, to obtain a ranking;
selecting at least one concept of the set of identified concepts based on the ranking, to obtain at least one selected concept; and
associating a visual representation with the report based on said at least one selected concept.

15. A computer program product comprising instructions for causing a processor system to perform the method according to claim 14.
